(19) United States
(12) Patent Application Publication
(10) Pub. No.: US 2010/0028483 A1
(43) Pub. Date: Feb. 4, 2010

(54) SOLID EDIBLE PRODUCT FOR A PET

(75) Inventors: Ute Wasserfuhr, Verden (DE); Martina Hurlebaus, Verden (DE)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA (US)

(21) Appl. No.: 12/463,703

(22) Filed: May 11, 2009

(30) Foreign Application Priority Data
May 9, 2008 (GB) 0808491.5
Jun. 2, 2008 (GB) 0809662.0

(51) Int. Cl. A23K 1/16; A23L 1/30

(52) U.S. Cl. 426/2; 426/61

(57) ABSTRACT

The present invention relates to a solid edible product for a pet having a moisture content of less than or equal to 10% comprising fat, a probiotic micro-organism and optionally a sweetener, a palatant and/or bulking material. The edible product may contain other ingredients. The invention also relates to a pet food product which comprises such a solid edible product as well as the solid edible product for improving or maintaining the health of a pet animal.

### CROSS-REFERENCE TO RELATED APPLICATIONS

This Application claims priority from GB Application 0808491.5 filed on May 9, 2008 in the United Kingdom and GB Application 0809662.0 filed on Jun. 2, 2008 in the United Kingdom.

### TECHNICAL FIELD

The present invention relates to a solid edible product for a pet having a moisture content of less than or equal to 10% comprising fat, a probiotic micro-organism and optionally a sweetener, a palatant and/or bulking material. The edible product may contain other ingredients. The invention also relates to a pet food product which comprises such a solid edible product as well as the solid edible product for improving or maintaining the health of a pet animal.

### BACKGROUND OF THE INVENTION

There is a continuing need in the art to provide nutritious, healthy and palatable pet food products, which are practical to produce and which provide a variation in a pet's diet, as well as providing variety to the pet food owner. The present invention provides such a pet food product, as well as the use of such a pet food product in improving or maintaining the health of a pet animal.

### BRIEF SUMMARY OF THE INVENTION

Accordingly, a first aspect of the present invention provides a solid edible product for a pet having a moisture content of less than or equal to 10% comprising fat, a probiotic micro-organism and optionally a sweetener, a palatant and/or bulking material.

The product has a low moisture content in order to protect the probiotic micro-organism. The moisture content may be less or equal to 10% and may be, for example, less than or equal to 7%, less than or equal to 5%, less than or equal to 3% or less than or equal to 2%. Preferably, the water activity (the Aw) of the food product is below 0.7. More preferably the Aw is from 0.6 to 0.01. In a most preferred embodiment, the water activity of the product is below 0.2, such as 0.2, 0.15, 0.1, 0.05 or 0.025.

In a preferred embodiment, the pet is the domestic cat or the domestic dog.

The fat content of the product may be above 20% up to 99.9%, preferably from around 45% to 75%. More preferably, the fat content may be from 40% upwards, for example 40 to 75%, or 50% upwards, for example 50 to 75%, or 55% upwards, for example 55% to 75%. The fat may be at least partly hydrogenated and/or fractionated and fats with a lower percentage of short fatty acid chains are preferred. The fat may be of plant and/or animal origin. There may be a single type of fat or two or more types of fat in the product. In particular, the fat may be one or more of palm oil, cottonseed oil, soya bean oil, rapeseed oil, palm kernel oil, coconut oil, butter oil, fish oil, sunflower oil, poultry fat, lard or tallow. The choice of fat may depend on the animal for which the product is being designed. The fat can be any known to the skilled person for use in such a product.

Preferably, the edible product is in the form of individual droplets or button shaped pieces which can be fed to a pet animal alone or which can be admixed with any other pet animal foodstuff. Preferably, the dimensions of the solid edible product are from approximately 0.5 cm in diameter to 2 cm in diameter, preferably approximately lcm in diameter. The products can be of any shape, including spheres, circles, squares, droplets, rectangles, stars or irregular shapes, or for example it may look like a chocolate bar, such that the owner breaks individual pieces off for the pet animal to consume.

The product may contain one or more sweeteners. The sweetener content is typically from 0-30%. The sweetener may be a caloric and/or a non- or reduced-caloric sweetener. Examples of caloric sweeteners are mono- and/or di-saccharid, potentially oligo-saccharids, such as sucrose, fructose, glucose, galactose, malto-dextrins. Examples of non or reduced caloric sweeteners are aspartame, saccharin, cyelamate, acesulfame K, L-aspartyl-L-phenylalanine lower alkyl sweeteners, L-aspartyl-D-alanine amides, L-aspartyl-D-serine amides, L-aspartyl-hydroxymethyl alkane amide sweeteners, L-aspartyl-L-hydroxyethylalkane amide sweeteners, glycyrrhizins or synthetic alkoxy aromatics or trehalose.

Preferably, where the fat or the product does not make the product particularly palatable for an animal, the product may contain a palatant. The palatant may be in the form of a powder or a liquid or a gel. In particular, the palatant may comprise fish and/or meat product and/or a yoghurt component, particularly yoghurt powder. The palatant comprising fish and/or meat product may make the edible product particularly palatable for a pet animal. The palatant may be a cheese powder, a yeast powder, a cheese or butter or other dairy derivative or by-product. The palatant may comprise one or more of meat or fish digests or meat or fish by-product digests. The palatant may comprise a chemical component, i.e. a synthetic component. Such a chemical component is preferably suitable and known to improve the pet's acceptance of a food product. Preferably, the palatant content is from 0% to 30% of the solid edible product, or 0.5% to 30% of the solid edible product.

The probiotic micro-organism in the product may be any, in particular one from the genera Bifidobacterium, Bacteroides, Clostridium, Fusobacterium, Melissococcus, Propionibacterium, Streptococcus, Enterococcus, Lactococcus, Staphylococcus, Peptostrepococcus, Bacillus, Pediococcus, Micrococcus, Leuconostoc, Weissella, Aerococcus, Oenococcus and Lactobacillus. Probiotic yeasts and moulds may also be used. Specific examples of suitable probiotic micro-organisms are: Bacillus coagulans, Bacillus licheniformis, Bacillus subtilis, Bifidobacterium bifidum, Bifidobacterium infantis, Bifidobacterium longum, Enterococcus faecium, Enterococcus faecalis, Lactobacillus acidophilus, Lactobacillus alimentarius, Lactobacillus casei subsp. casei, Lactobacillus casei, Shirota, Lactobacillus curvatus, Lactobacillus delbruckii subsp. lactis, Lactobacillus farciminus, Lactobacillus gasseri, Lactobacillus helveticus, Lactobacillus johnsonii, Lactobacillus reuteri, Lactobacillus rhamnosus (Lactobacillus GG), Lactobacillus sake, Lactococcus lactis, Micrococcus varians, Pediococcus acidilactici, Pediococcus pentosaceus, Pediococcus acidilactici, Pediococcus halophilus, Streptococcus faecalis, Streptococcus thermophilus, Staphylococcus carnosus, and Staphylococcus xylosus. or combinations thereof. Preferably, the probiotic micro-organism is Lactobacillus acidophilus deposited under the Accession Number NCIMB41117 or Enterococcus faecium deposited under the Accession Number NCIMB 41546.

The Lactobacillus acidophilus strain has been deposited at the NCIMB Ltd under the Accession Number NCIMB 41117 on the 10 Oct. 2001. The following details apply for growing the micro-organism:

Growth media: acidified M.R.S (de Man, Rogosa and Sharp) agar.

Incubation atmosphere: Anaerobic atmosphere of 80% (v/v) nitrogen, 10% (v/v) hydrogen and 10% (v/v) carbon dioxide.

Incubation temperature: 38° C.

Incubation period required: 1 day.

The Enterococcus faecium strain has been deposited at the NCIMB Ltd under the Accession Number NCIMB 41546 on 17 Apr. 2008. The following details apply for growing the micro-organism:

Growth media: Brain heart infusion agar supplemented with defibrinated horse blood (5%).

Incubation atmosphere: Anaerobic atmosphere of 80% (v/v) nitrogen, 10% (v/v) hydrogen and 10% (v/v) carbon dioxide.

Incubation temperature: 37° C.

Incubation period required: 1 day.

The probiotic micro-organism may be a single strain or more than one strain and the strain may vary depending on the animal for which the product is designed, in particular whether it is a young or old animal or an animal with ill health or good health.

Typically, the probiotic micro-organism is present in the product from around 10³ to 10¹⁰ cells per gram of the product. The amount of the probiotic micro-organism can vary depending on the amount of probiotic to be delivered to the animal by the pet food product. The probiotic micro-organism is preferably present throughout the solid edible product and is produced by admixing the micro-organism with the other ingredients of the product. The probiotic micro-organism may be present in a form which is already at least partly protected, for example it may be in a dried or freeze-dried form or may be encapsulated. The probiotic may be present on the surface of the product.

The probiotic may be in any form. The probiotic may be in dried, powdered form, such as spore form. It may be in liquid form or a semi-solid form, such as within a gel, or similar, matrix. It may be encapsulated in any form, such as a solid or liquid matrix or envelope, as known in the art.

The product may contain a bulking agent in order to improve either the manufacture, the texture and/or the palatability of the product. The bulking agent may be any one or more of the following, which may be cooked: breadcrumbs, flour, puffed grains, particles from cereals or cereal by-products or vegetable pieces or extrudates derived from cooking extrusion processes (for example the extrudate from known dry pet food recipes) which may be in the form of a gelatinised starch matrix, as known in the art. The bulking agent may be or be derived from wheat, rice or corn (maize) e.g. flour from these cereals. The bulking agent may be in the form of a low density kibble or crisp (e.g. standard pet food kibbles or crisp-type cereal pieces).

The bulking agent may be from 0-80% of the product, in particular around 30-70% or 40-60% of the product.

A second aspect of the present invention provides a pet food product which comprises the solid edible product of the first aspect of the invention. Such a pet food product may comprise only the solid edible product of the first aspect of the invention or may comprise a mixture of another pet food together with the solid edible product of the first aspect of the invention. The “other” pet food may be a pet food in its own right or may be a pet food snack. Pet foods in their own right include a dry, semi-moist or a moist (wet) product. Wet food includes food that has a moisture content of 70%-90% and is usually sold in containers such as tins, pouches and/or trays. Dry food includes food having a similar composition but with 5%-15% moisture, often presented as small biscuit-like kibbles. Semi-moist food includes food having a moisture content of from above 15% up to 70%. The amount of moisture in any product may influence the type of packaging that can be used or is required. The “other” food product, of any moisture level, may be ready to eat. The pet food snack includes snack bars, cereal bars, snacks, biscuits, drinks (e.g. cat milk) and sweet products.

The “other” pet food product may be a cooked product, it may incorporate meat or animal derived material (such as beef, chicken, turkey, lamb, fish, blood marrow, marrowbone, etc or one or more thereof). Alternatively, the composition may be meat-free (preferably including a meat substitute such as soya, maize, gluten or a soya product) in order to provide protein. The composition may contain additional protein sources such as soya protein concentrate, milk, protein, gluten etc. The composition may also include starch, such as one or more grains (e.g. wheat, corn, rice, oats, barley etc) or may be starch free. The composition may incorporate or may be a gelatinised starch matrix. The composition may incorporate one or more types of fibre such as sugarbeet pulp, chicory pulp, chicory, coconut endosperm fibre, wheat fibre, fructooligosaccharides, galactooligosaccharides, inulin etc. The fibre may be a prebiotic. The combination of the probiotic and the prebiotic may form a synbiotic combination. Dairy products such as those incorporating a cream or a cheese may be suitable. The most suitable composition is pet food described herein which is sold as a pet food and in particular a pet food for a domestic dog or a domestic cat. Preferably, the pet food is in a dry format, such as a dried ready-to-eat cereal product comprising a cooked starch matrix produced by extrusion cooking and referred to as pet kibble.

The pet food which incorporates the solid edible product of the first aspect of the invention and another pet food is preferably a packaged pet food which comprises a mixture of two or more different types of food products. Alternatively both are packed in separate packs but attached to one sales unit. When the food product of the first aspect is combined with another product, the combined water activity of the mixture as a whole should preferably not exceed 0.7. More preferably the Aw is below 0.6, or is 0.2 or less.

A third aspect of the invention provides a product according to the first or second aspects of the invention for improving or maintaining the health of a pet animal. A fourth aspect of the invention provides the use of a product according to the first or second aspects of the invention in the manufacture of a pet food for improving or maintaining the health of a pet animal. A fifth aspect of the invention relates to a method of improving or maintaining the health of a pet animal, the method comprising feeding said pet animal a product, as set out in any of the first or second aspects of the invention.

In terms of the third, fourth and fifth aspects of the invention, the solid edible products are suitable for improving and/or maintaining the health of a pet animal. The health of a pet animal can be improved if the animal's health is not considered acceptable. If a pet animal already has an acceptable level of health, then the solid edible food products are suitable for maintaining the health of a pet animal. The health effect predominantly arises from the presence of the probiotic micro-organism within the product. Probiotics are often described as dietary supplements containing a potentially beneficial bacteria and according to the currently adopted definition are live micro-organisms which can confer a health benefit on the host. Probiotic micro-organisms assist the body's naturally occurring gut flora to re-establish themselves. Probiotic micro-organisms are reported and known to strengthen the immune system and prevent infections, reduce inflammation, improve mineral absorption, prevent the growth of harmful bacteria, assist in improving the systems of irritable bowel syndrome and colitis, lower cholesterol, assist in the prevention of colon cancer, lower blood pressure and assist in the management of lactose intolerance. The present invention provides a nutritious, healthy and palatable pet food which is practical to produce and which provides a variation in the pet's diet, as well as providing variety to the pet food owner.

A sixth aspect of the invention relates to a method of making a solid edible product for a pet according to the first aspect of the invention comprising mixing the components together, optionally with heating and forming the solid edible product. Heating may be required in order to manipulate the content of fat to be included in the product. Alternatively, mixing or beating of the fat can be carried out to mix the other components where a bulking agent is part of the solid edible product, the method may preferably involve adding the bulking agent separately to the other components of the product. The other components may be mixed together first, before adding to the bulking agent. Addition of the fat and probiotic, optionally at the same time as the other ingredients, to a bulking agent, may be carried out by a process of coating the bulking agent with the other components and then applying a vacuum (known as vacuum coating) described in WO 2001/95745. Alternatively, the components of this solid edible product can be produced by forming droplets through a valve as shown in FIG. 1.

The sixth aspect of the invention also includes a method of making a pet food product according to the second aspect of the invention. This method is preferably carried out by admixing the solid edible product of the first aspect of the invention to the other form of pet food as described in relation to the second aspect of the invention.

All preferred aspects of the invention apply mutatis mutandis to the other aspects of the invention.

### BRIEF DESCRIPTION OF THE DRAWINGS

The invention will now be described with reference to the following Figures and Examples, which are not limiting and merely serve to exemplify the invention, in which:

FIG. 1 is a diagrammatic representation of a solid drop product according to Example 1 being manufactured;

FIG. 2 is a graph showing the increased preference of dogs for the solid edible product of the invention where A is a dry dog food with 10% of a solid edible pet food product representative of Example 1; and B is a dry dog food without a solid edible pet food product representative of Example 1;

FIG. 3 is a graph showing the increased preference of cats for the solid edible product of the invention, where C is a standard dry cat food without a solid edible food product representative of Example 1; and D is a standard dry cat food with 10% of a solid edible food product representative of Example 1;

FIG. 4 is a graph showing the increased preference of dogs for an alternative embodiment of the solid edible product of the invention, where A is a dry dog food with 10% of the solid edible crisp product representative of Example 2; and B is a dry dog food without the solid edible crisp product representative of Example 2; and

FIG. 5 is a graph showing the increased preference of cats for an alternative embodiment of the solid edible product of the invention, where C is a dry cat food with 10% of the solid edible crisp product representative of Example 2; and D is a dry cat food without the solid edible crisp product representative of Example 2.

### DETAILED DESCRIPTION OF THE INVENTION

### EXAMPLES

### Example 1

Manufacture of a solid edible product in accordance with the first aspect of the invention:

Ingredients:

60% hydrogenated, partly fractionated palm oil (Fat)

15% yoghurt powder (Palatant)

25% icing sugar (Sweetener)

0% Bulking agent

Probiotic at a concentration of 2×10⁷ cfu/g carrier recipe. The probiotic is Lactobacillus acidophilus deposited under the Accession Number NCIMB 41117 in powdered format.

The product, in the form of relatively high fat droplets, was produced by the following condition:

The product was manufactured by mixing the ingredients above under the conditions of 35-55° C. constantly for 45 minutes.

The mix was led from the mixing tank through a heated pipe into a droplet forming valve.

The valve dispensed the drops onto a cooling belt (as an alternative a cooling drum could be used) that was running at slow speed.

The drops hardened on the belt and were collected at the end of the cooling belt.

The solid product was determined to have a moisture content lower than 5%. The A_{w} was measured to be 0.47.

The drops were packed into moist- and air tight packaging.

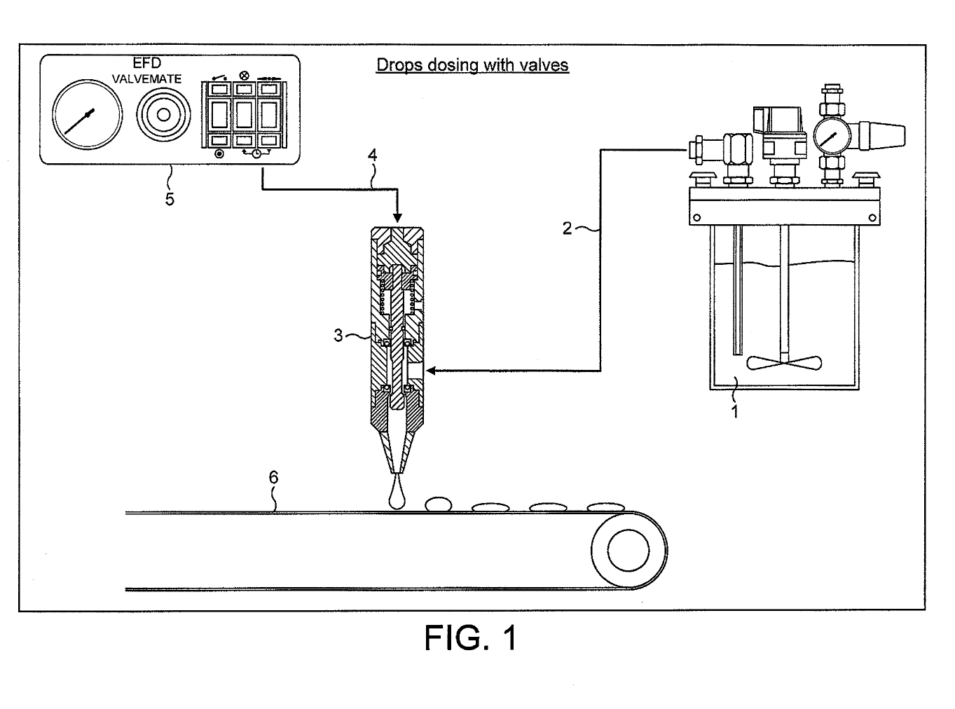

The process is exemplified in FIG. 1.

### Example 2

Manufacture of a solid edible product in accordance with the first aspect of the invention.

Ingredients:

30% pork fat

2.5% Palatant (palatability enhancement powder from a digest mixture)

68.5% Bulking agent in the form of an extruded low density kibble, made by high pressure cooker extrusion and air dried to the required moisture. The kibble ingredients are predominantly a mixture of rice flour (minimum 26%), wheat flour and hydrogenated vegetable fat (at approximately 70% rice flour, 20% wheat flour, 5% wheat gluten and a combined total of 5% of salt, sugar and vegetable fat).

Probiotic at a concentration of 2×10⁷ cfu/g carrier recipe. The probiotic is Lactobacillus acidophilus deposited under the Accession Number NCIMB 41117

The product in the form of a “crisp” product was produced by the following conditions:

The product was manufactured by mixing all of the ingredients above with the exception of the bulking agent—under the temperature conditions of between 20-55° C.

The bulking agent was pre-dried to less than 2% moisture. Then, the bulking agent and the mixture of the other ingredients were put into a vacuum coater, where the fat mix was incorporated into the bulking agent (standard procedure of vacuum coating, as known to the skilled person, an example of which is described in WO 2001/95745.

The solid product was determined to have a moisture content of below 2%. It was dried down to this moisture content on an air dryer. The solid product was determined to have an A_{w} of less than 0.2. The A_{w} was measured under standard conditions (ambient temperature at around 23° C.±2° C.) using an Aqualab3 device from Decagon (an alternative is a Hygrolab2 device from Rotronic).

The final “crisp” product was packed into moist- and air-tight packaging.

### Example 3

Palatability studies, with dogs and cats, using the solid edible product according to the invention were conducted.

An experiment was conducted to determine palatability of a dry pet food product comprising 10% (by weight) of the solid edible “droplet” pet food product of Example 1 (without probiotic) (A and D) versus the same dry pet food without inclusion of any solid edible “droplet” (B and C). The high fat droplets were made without probiotics for palatability studies, since the probiotic organism has no influence on palatability.

The palatability was assessed by offering both products (dry pet food with fat droplets) at the same time to the pets (dogs or cats). The pets choose which product they preferred.

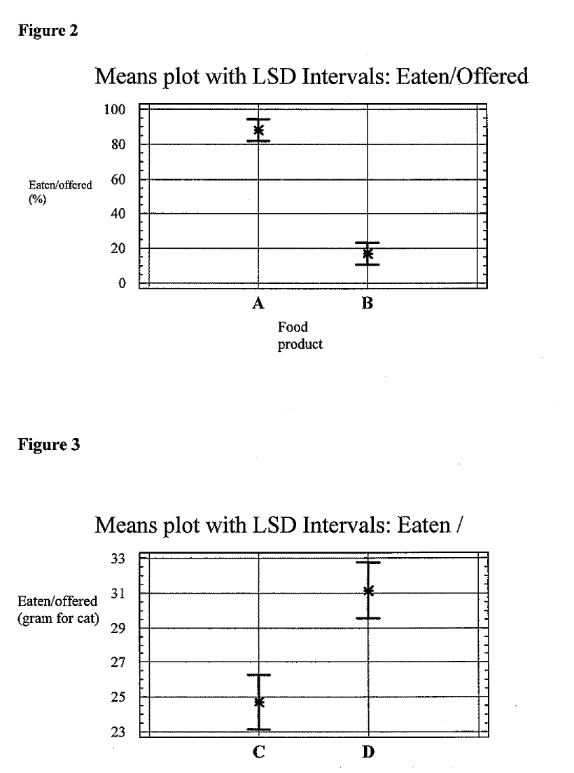

The results are shown in FIGS. 2 and 3.

The dogs significantly (p=0.0000) preferred the product with droplets (A) to the product without droplets (B). The dogs ate, on average, more than 80% of the product with droplets and less than 20% of the product without droplets.

The cats significantly (p=0.0001) preferred the product with droplets (D) to the product without droplets (C). The cats ate, on average, more than 31 grams of the product with droplets and less than 25 g of the product without droplets.

### Example 4

Palatability studies using the solid edible product according to the invention were conducted.

An experiment was conducted to determine palatability of a dry pet food kibble product comprising 10% (by weight) of the solid crisp product of Example 2 (without probiotic) (A and C) versus the same dry pet food kibble product without inclusion of the solid crisp product of Example 2 (B and D). The solid crisp product was made without probiotics for the study, since the probiotic organism has no influence on palatability.

The palatability was assessed by offering both products (one with, one without the crisp component) at the same time to the pets (cats or dogs). The pets chose which product they preferred.

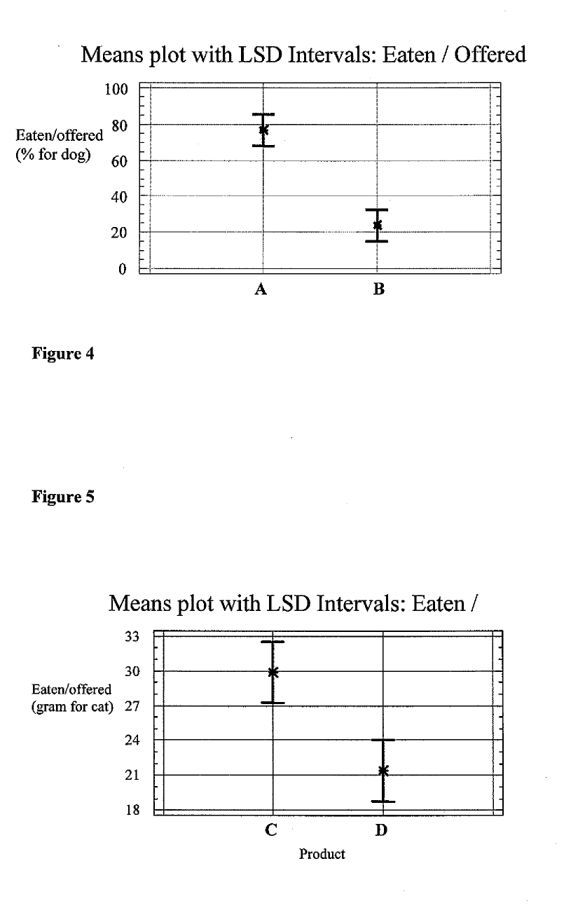

The results are shown in FIGS. 4 and 5.

The dogs significantly (p=0.0000) preferred the food with the crisp product (A) to the one without the crisp product (B). The dogs ate, on average, more than 75% of the food with the crisp product and less than 25% of the food without the crisp product.

The cats significantly (p=0.0018) preferred the food with the crisp product (C) to the one without the crisp product (D). The cats ate, on average, more than 30 g of the food with the crisp product and less than 22 g of the food without the crisp product.

The results show that the food containing the solid edible droplet as well as the crisp product performed significantly better than its counterpart without the inclusion of the solid edible pet food product of the invention for both dogs and cats.

Thus, the product of the present invention provides palatable variety to a pet animal while increasing the health status of the pet animal.

### Example 5

The stability of solid edible product of the invention was tested.

Two embodiments of the product were tested. The two samples of the products tested were as follows;

1. A crisp product with 30% fat, 2.5% palatant and Lactobacillus acidophilus deposited under the Accession No. NCIMB41117 (as described in Example 2).

2. A fat droplet product with 60% fat, 15% palatant, 25% sugar and Lactobacillus acidophilus deposited under the Accession Number NCIMB41117 (as described in Example 1).

The products were stored for six months, and the viability of the probiotic organism was tested periodically.

As can be seen, the probiotic remained stable even after six months. It can be envisaged that it would remain stable for much longer.

TABLE 1

| | | After | | | | | |
|---|---|---|---|---|---|---|---|
| Sample | T = 0 | 1 month | 2 months | 3 months | 4 months | 5 months | 6 months |
| 1 | 1.05E+07 | 5.55E+07 | 1.40E+07 | 2.25E+07 | 4.95E+07 | 4.40E+07 | 4.05E+07 |
| 2 | 5.90E+07 | 8.43E+07 | 8.23E+07 | 1.73E+07 | 2.65E+07 | 4.768E+07 | 2.35E+07 |

Average from 2 Agars

In these microbiological tests, a deviation of +/−0.3 log is within the standard measurement variation.

A copy of the Receipt in the Case of an Original Deposit under the Budapest Treaty on the International Recognition of the Deposit of Microorganisms for the Purpose of Patent Procedure for the Lactobacillus acidophilus strain is on page 14.

A copy of the Receipt in the Case of an Original Deposit under the Budapest Treaty on the International Recognition of the Deposit of Microorganisms for the Purpose of Patent Procedure for the Enterococcus faecium strain is on page 15.

1. A solid edible product for a pet having a moisture content of less than or equal to 10%, comprising: fat, a probiotic micro-organism, a palatant and/or bulking material.

2. The edible product, as claimed in claim 1, wherein the fat content is from above 20% up to 99.9%.

3. The edible product, as claimed in claim 1, wherein the sweetener content is from 1 to 30%.

4. The edible product, as claimed in claim 1, wherein the palatant is in the form of a powder.

5. The edible product, as claimed in claim 1, wherein the palatant content is up to 20%.

6. The edible product, as claimed in claim 1, wherein the probiotic is selected from the genera consisting of Lactobacillus, Bifidobacterium, Bacillus, Bacteroides, Enterococcus, Saccharomyces and combinations thereof.

7. A pet food product comprising: a solid edible product having a moisture content of less than or equal to 10%, and comprising fat, a probiotic micro-organism, a palatant and/or bulking material and another form of pet food.

8. The pet food product as claimed in claim 7, further comprising a mixture of pet kibbles and the edible product.

9. (canceled)

10. A method of making a solid edible product for a pet comprising the steps of:
mixing together components comprising fat, a probiotic micro-organism and a palatant;
adding a bulking agent to the components; and
heating and forming the solid edible product.

11. The solid edible product of claim 1, further including a sweetener.

12. The edible product, as claimed in claim 1, wherein the fat content is from about 25 to 75%.

13. The solid edible product of claim 1, wherein the fat content is from about 40 to 75%.

14. The edible product, as claimed in claim 1, wherein the palatant content is from 0.5 to 10%.

15. A method of improving or maintaining the health of a pet animal, the method comprising feeding said animal a solid edible product having a moisture content of less than or equal to 10% and comprising a fat, a probiotic micro-organism, a palatant and/or bulking material.

16. The method of claim 15, wherein the edible product further includes a sweetener.
